(19) United States
(12) Patent Application Publication
(10) Pub. No.: US 2013/0057125 A1
(43) Pub. Date: Mar. 7, 2013

(54) MULTIFUNCTIONAL STORAGE BOX

(71) Applicant: PEI-CHUAN MA, Taipei City (TW)

(72) Inventor: PEI-CHUAN MA, Taipei City (TW)

(21) Appl. No.: 13/666,987

(22) Filed: Nov. 2, 2012

Related U.S. Application Data
(63) Continuation-in-part of application No. 13/007,993, filed on Jan. 17, 2011.

(51) Int. Cl. A47B 47/00; F16B 12/00

(52) U.S. Cl. 312/108

(57) ABSTRACT

A multifunctional storage box includes an elementary unit composed of two horizontal boards, two vertical boards, and inlaid members inlaid in an end of the elementary unit. Each of the vertical boards comprises first and second board segments connected to each other by a movable connection member. Each of the horizontal and vertical boards has an end forming a groove. Holes are formed in the grooves. The horizontal and vertical boards also form locking holes in communication with the holes. Each of the inlaid members is of a T-shape and has pins each having a retention section. The pins are respectively fit in the holes of the horizontal boards and the vertical boards. Positioning elements are respectively screwed into the locking holes to engage and couple the retention sections of the pin so as to fix the boards together to form a piece of furniture.

### CROSS-REFERENCE TO RELATED APPLICATION

This application is a continuation-in-part of the co-pending patent application Ser. No. 13/007,993, owned by the same applicant.

### TECHNICAL FIELD OF THE INVENTION

The present invention generally relates to a multifunctional storage box, and more particularly to a multifunctional storage box that, after being properly assembled, can receive and store various articles, or can be stacked in multiplicity to form a piece of furniture, such as drawer, closet, and desk, or can be folded into a flat configuration for easy carrying and storage when not in use.

### DESCRIPTION OF THE PRIOR ART

A storage box that functions to receive and store articles therein is often composed of a basic frame made of wood or plastics and a plurality of shelves that forms storage spaces for receiving and storing articles. The conventional storage box, although allowing a user to assemble by himself or herself, is of a fixed structure that prevents the box to be folded when not in use so that the storage box occupies a large amount of space and is difficult to carry. Although disassembling the storage box may be helpful in addressing these problems, yet it would be a tedious job for re-assembling is time consuming. Further, the conventional storage box is often used as an individual stand-alone device and cannot be stacked or juxtaposed in multiplicity to show a different form of utility. The present invention thus aims to provide an improved storage box structure that can be used as a stand-alone device or can be stacked in multiplicity to show another form of utility.

### SUMMARY OF THE INVENTION

An objective of the present invention is to provide a multifunctional storage box, which after being properly assembled, can receive and store various articles, or alternatively be stacked in multiplicity to form a piece of furniture, such as drawer, closet, and desk, and is foldable into a flat configuration to facilitate carrying and storage when not in use.

The multifunctional storage box comprises an elementary unit comprising two horizontal boards, two vertical boards, and inlaid members inlaid in an end of the elementary unit, wherein each of the two vertical boards comprises a first board segment and a second board segment connected to each other by a movable connection member coupling between the first and second board segments. Each of the two horizontal boards and the two vertical boards has an end forming a groove. Holes are formed in the grooves. The two horizontal boards and the two vertical boards also form locking holes in communication with the holes. Each of the inlaid members is of a T-shape and comprises pins having retention sections. The pins are respectively fit in the holes of the two horizontal boards and the two vertical boards. Positioning elements are respectively screwed into the locking holes to engage and couple the retention sections of the pins to thereby form a piece of furniture, such as drawer, closet, and desk, of which assembling is easy, whereby when not in use, the inlaid members are removable and the first and second board segments are foldable inward by means of the movable connection members into a flat configuration for easy carrying and storage.

In the previously discussed structure of multifunctional storage box, in an opposite end of the elementary unit, a notch is formed in an end of each of the horizontal boards and a vertically extending slide slot and mounting holes are formed in an inside surface of each of the vertical boards at a location corresponding to the notch. The positioning piece has a top edge forming a flat flange substantially aligning the notch. The flat flange forms through holes corresponding to the mounting holes, whereby with the positioning piece being received and vertically sliding down along the slide slots, pins are received through the through holes and fit into the mounting holes to secure the positioning piece in position.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1 and 2 are exploded view showing a first embodiment according to the present invention.

FIGS. 2 and 3 are exploded views of inlaid members and positioning elements of the first embodiment according to the present invention.

FIG. 4 illustrates engagement between a pin and the positioning element according to the present invention.

FIG. 5 illustrates a use of the first embodiment of the present invention.

FIG. 6 is a perspective view of a second embodiment of the present invention.

FIG. 7 is a perspective view of a third embodiment of the present invention.

FIG. 8 is a perspective view of a fourth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

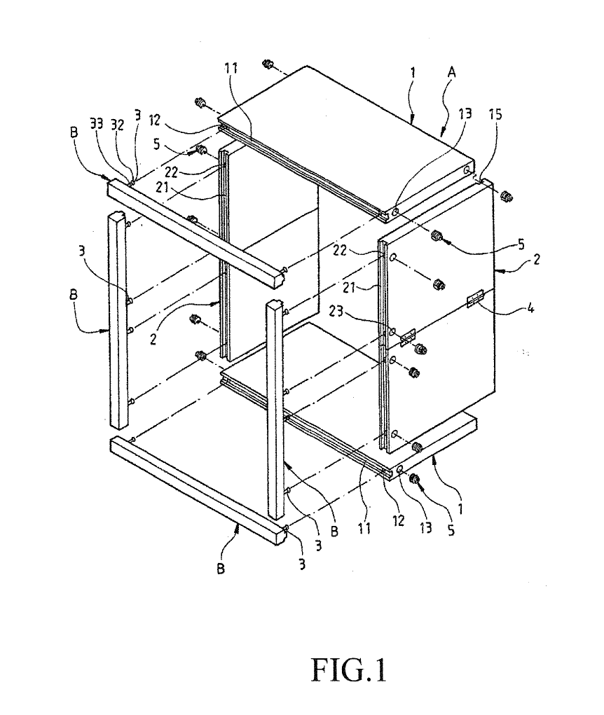

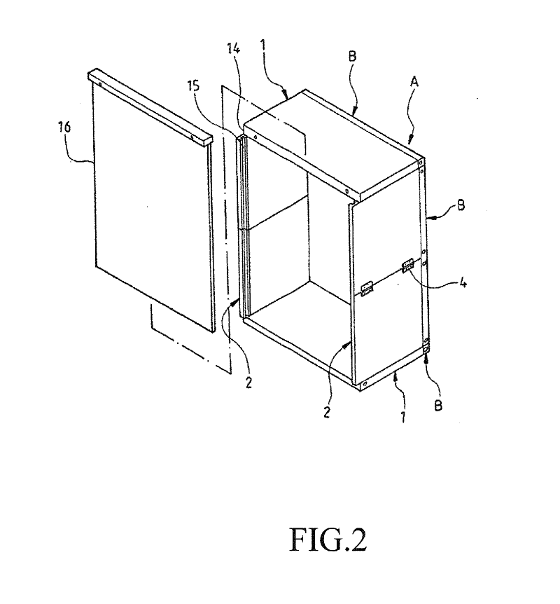

Referring to FIGS. 1, 2, and 3, an exploded view showing a first embodiment according to the present invention and exploded views of inlaid member and positioning element are given. As shown in the drawings, the present invention comprises a frame like elementary unit A composed of two horizontal boards 1 and two vertical boards 2 and inlaid members B that are inlaid in an end of the elementary unit A. The two vertical boards 12 are each composed of a first board segment and a second board segment that are connected to each other. The first and second board segments comprise movable connection members 4 connecting therebetween and in the instant embodiment, the connection members 4 are hinges or other movable connection elements.

Each of the two horizontal boards 1 and the two vertical boards 2 has an end forming a groove 11, 21. Holes 12, 22 are formed in the grooves 11, 21. The two horizontal boards 1 and the two vertical boards 2 also form locking holes 13, 23 in communication with the holes 12, 22. Each of the horizontal boards 1 has an opposite end forming a notch 14. A vertically extending slide slot 15 is formed in an inside surface of each of the vertical boards 2 at a location corresponding to the notch 111, and mounting holes 14 corresponding to the notch 14. A T-shaped board 16 is slidably received in the slide slots 15 to move down from the top so that the board 16 is positioned and fixed.

Each of the inlaid members B is of a T-shape and comprises pins 3, each of which has a locking section 31 having a predetermined length and an expanded section 32 having an enlarged diameter. A retention section 33 having a reduced diameter is formed between the locking section 31 and the expanded section 32. The locking section 31 is fit into and fixed in the inlaid member B so as to mount the pin 3 to the inlaid member B.

With the above discussed components properly assembled, the inlaid members B are respectively inlaid in the grooves 11, 21 of the horizontal boards 1 and vertical boards 2 and the pins 3 are respectively fit in the holes 12, 22 of the horizontal boards 1 and the vertical boards 2. Positioning elements 5 are then respectively screwed into the locking holes 13, 23 to engage and couple the retention sections 33 of the pins 3 thereby fixing the inlaid members B in position and thus forming a piece of furniture, such as a drawer, a closet, and a desk, whereby the assembling is easy. When not in use, the inlaid members B can be removed, and with the aid of the movable connection members, the first and second board segments can be folded inward to form a flat configuration, which helps carrying and storage. Each of the positioning elements 5 has a bottom forming a notch 51, a helical groove 52 extending from the notch 51 by a predetermined length, and a top forming a force application section 53, whereby with the aid of the force application section 53, the positioning element 5 can be rotated to have the retention section 33 of the corresponding pin 3 to fit into and retained in the helical groove 52 thereby fixing the inlaid member B to the horizontal board 1 or the vertical board 2. The locking operation is effortless and the installation of the hinge is easy.

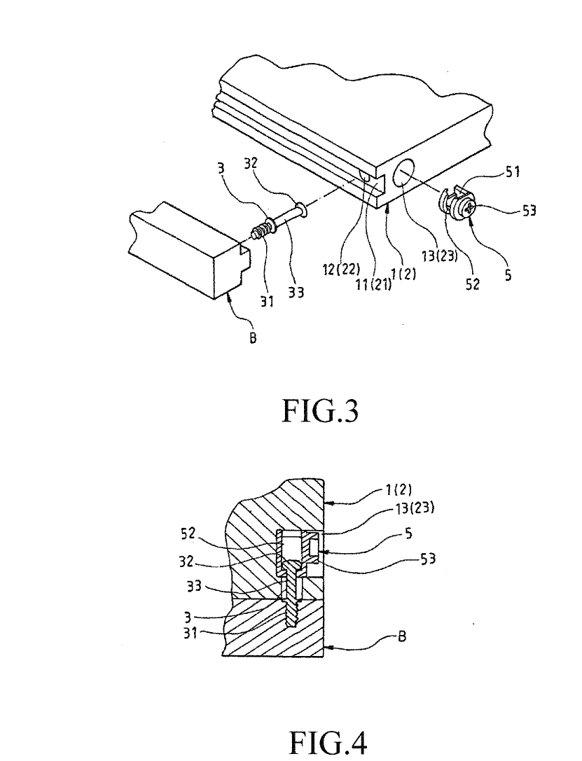

Referring to FIG. 4, a view showing the engagement between the pin and the positioning element is given. Also referring to FIG. 3, as shown, the pins 3 of the inlaid members B according to the present invention are first fit into the holes 12, 22 of the two horizontal boards 1 and the two vertical boards 2 and the positioning elements 5 are screwed into the locking holes 13, 23 to have the expanded sections 32 of the pins 3 received into the notches 51 and further sliding from the notches 51 into the helical grooves 52 thereby setting and retaining the retention sections 33 of the pins in the helical grooves 52 and thus fixing the two horizontal boards 1 and the two vertical boards 2 and the inlaid members B together.

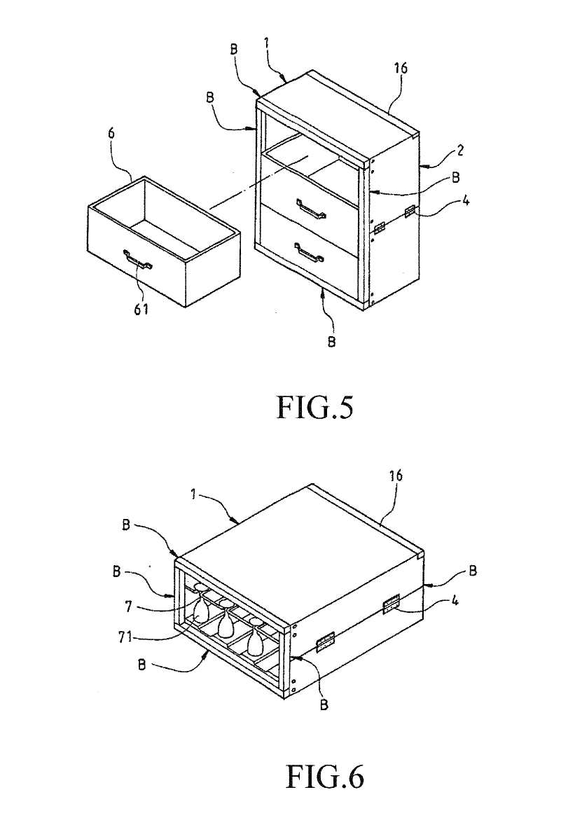

Referring to FIG. 5, a use of the first embodiment of the present invention is illustrated. As shown in the drawing, after being assembled, the present invention may receive drawers 6 having handles 61 to be respectively fit into the storage box to form a plurality of drawers 6 and thus forming a storage box in the form of a cabinet having a predetermined height, wherein the drawers 6 may be used to store and deposit clothes and other articles.

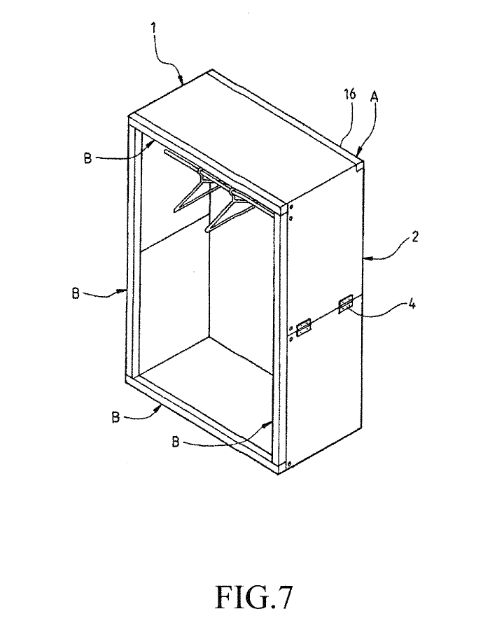

Referring to FIG. 6, a perspective view of a second embodiment of the present invention is illustrated. As shown in the drawing, after being assembled, the present invention may form a case like storage box, which may receive and retain therein a suspension frame 7 for storing glasses 71 in a suspended fashion.

Referring to FIG. 7, a perspective view of a third embodiment of the present invention is illustrated. As shown in the drawing, the present invention may include two horizontal boards 1 and two vertical boards 2 that are of an enlarged size to be used in combination with corresponding inlaid members B that support and retain the two horizontal boards 1 and the two vertical boards 2 in position to form a closet like storage box, in which clothes and accessories of clothes can be suspended.

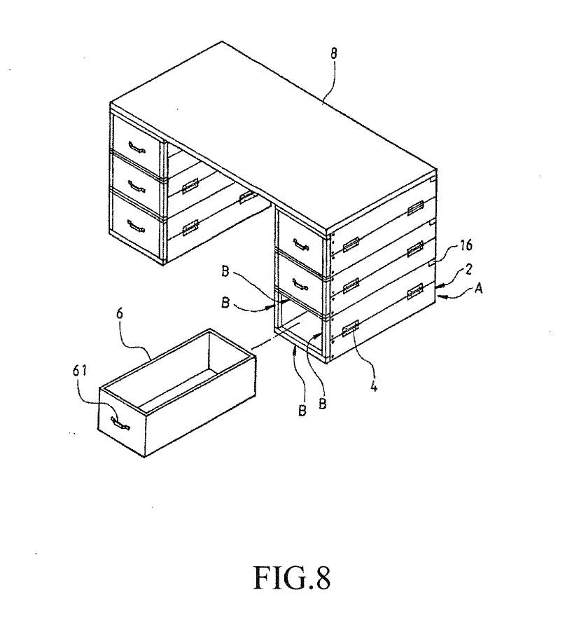

Referring to FIG. 8, a perspective view of a fourth embodiment of the present invention is illustrated. As shown in the drawing, after assembled, the present invention allows a number of the storage to be stacked and fixed together. Drawers 6 that are of different sizes and have handles are respectively received in the stacked storage boxes. A top board 8 may then be positioned on and supported by two stacks of the storage boxes to form a desk.

In summary, the present invention provides an elementary unit composed of horizontal boards and vertical boards, incorporating with inlaid members attached to the elementary unit, to form a multifunctional storage box, which after being properly assembled, may receive and store various articles therein, or alternatively, a number of such storage boxes may be stacked to form a piece of furniture, such as drawer, closet, and desk. When not in use, the storage box can be folded to a flat configuration for easy carrying and storage.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multifunctional storage box, comprising an elementary unit comprising two horizontal boards, two vertical boards, and inlaid members inlaid in an end of the elementary unit, wherein each of the two vertical boards comprises a first board segment and a second board segment connected to each other by a movable connection member coupling between the first and second board segments, each of the two horizontal boards and the two vertical boards having an end forming a groove, holes being formed in the grooves, the two horizontal boards and the two vertical boards also forming locking holes in communication with the holes, each of the inlaid members being of a T-shape and comprising pins having retention sections, the pins being respectively fit in the holes of the two horizontal boards and the two vertical boards, positioning elements being respectively screwed into the locking holes to engage and couple the retention sections of the pins to thereby form a piece of furniture, such as drawer, closet, and desk, of which assembling is easy, whereby when not in use, the inlaid members are removable and the first and second board segments are foldable inward by means of the movable connection members into a flat configuration for easy carrying and storage.

2. The multifunctional storage box according to claim 1, wherein connection member coupling between the first board segment and the second board segment of the vertical board comprises a hinge.

3. The multifunctional storage box according to claim 1, wherein the positioning structure comprises a notch formed in an opposite end of each of the horizontal boards, a vertically extending slide slot being formed in an inside surface of each of the vertical boards at a location corresponding to the notch, a T-shaped board being slidably received in the slide slots to move down from the top so that the board is positioned and fixed

4. The multifunctional storage box according to claim 1, wherein the pins mounted to the inlaid members each comprise a rounded bar of a predetermined length and an expanded section, the retention section being formed between the round bar and the expanded section and having a reduced diameter.
